(19) United States
(12) Patent Application Publication
(10) Pub. No.: US 2021/0166230 A1
(43) Pub. Date: Jun. 3, 2021

(54) Cryptocurrency and Proof of Payment Protocol

(71) Applicant: Metallicus, Inc., San Francisco, CA (US)

(72) Inventor: Marshall Hayner, San Francisco, CA (US)

(73) Assignee: Metallicus, Inc., San Francisco, CA (US)

(21) Appl. No.: 17/019,165

(22) Filed: Sep. 11, 2020

Related U.S. Application Data
(60) Provisional application No. 62/899,059, filed on Sep. 11, 2019.

(51) Int. Cl. G06Q 20/40; G06Q 20/38

(52) U.S. Cl. CPC G06Q 20/401; G06Q 20/386; G06Q 2220/00; G06Q 20/389; G06Q 20/382

(57) ABSTRACT

A system and method for distributing a cryptocurrency using a distribution system is described. A request to transfer a first asset from a first user to a second user may be received by the system via a message received from a user device over a network, each user being associated with an account and a payment service. The first asset amount may be transferred by the system contacting the payment services of both users. In response to determining that the transferring has been settled, first and second amounts of a second asset to be determined and remitted to each of the first user and the second user respectively based on the first asset amount. The second asset may be an encrypted cryptocurrency asset associated with a blockchain stored on a server in communication with the distribution system.

Metallicus, Inc. is a San Francisco-based technology company that is building a blockchain-based payments and rewards processing platform. The products and services offered through the platform include the following:
MTL/Metal—Metallicus, Inc. has created and is distributing an electronic token called “Metal” (abbreviated “MTL”) which the company refers to as a cryptocurrency. Metallicus, Inc. has developed a loyalty rewards program that issues bonuses or awards denominated in MTL to users when they make purchases on or through the apps, to merchants for accepting MTL as payment and/or for converting fiat currencies into cryptocurrencies. Each time that Metallicus, Inc. processes (or oversees the processing of) a payment transaction through its apps or website, some amount of MTL is issued. Metallicus intends for these ongoing issuances to drive adoption and use of the MTL cryptocurrency. Metallicus, Inc. refers to its rewards program is referred to as the “Proof of Payments Protocol” (“PoPP”). Metallicus, Inc. will also occasionally sell MTL for U.S. dollars from its “operational reserves” in private transactions to partially fund its business operations.
MetalPay—Metallicus, Inc. has created and launched the Metal Pay mobile app, which it markets to users as a way to “make payments,” “send money” and “receive money” and (somewhat unusually), to “make money.” The company's intent is to allow users to create a relationship of trust on an open address. The company uses the term “Popscore” to refer to the number of relationships a user has and the quality of that user's payment history. For example, the Popscore algorithm looks at overdraws, rejections and fails as a buyer and a merchant.
The Metal Pay app uses Plaid to connect a user's bank account and the app requires the input of information to identify the user.
The Metal Pay app tells users that they can “get rewarded in cryptocurrency [(meaning MTL)] simply for making payments.” It also says that users can “cash out your Metal to your bank, or hold it and watch it grow.” The app has a “Turn to Cash” button that a user can click to send the U.S. dollar value of their MTL to the user's bank account.
Crumbs—Metallicus, Inc. also owns and operates the “Crumbs” mobile app. A user of the Crumbs app is shown several messages during the signup and usage processes as of Sep. 28, 2018, including the following messages:
   “Crumbs makes it easy for anyone to start investing in cryptocurrencies.”
   “Invest what you can spare. All you need is some spare change to start building your very own portfolio.”
   “Round up credit & debit purchases. We'll take the leftover change from your card purchases and invest into crypto for you.”

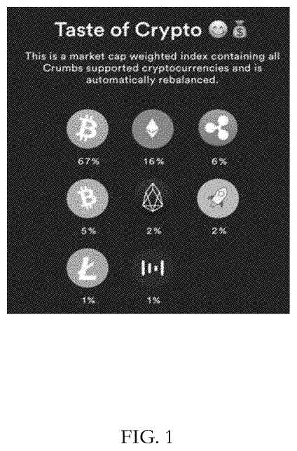

The Crumbs app allows a user to select an investment portfolio and the app describes the portfolio options using these descriptions:
i. “Marshall—This portfolio is all about Metal, the native cryptocurrency of Crumbs.”
ii. “Satoshi—This portfolio contains only bitcoin, the native asset of the Bitcoin protocol and the number one cryptocurrency in terms of market cap and trading volume.”
iii. “Vitalik—This portfolio is all about Ether, the cryptocurrency powered by the Ethereum blockchain.”
iv. “Foundation—This is the perfect portfolio for you if you're new to crypto investing. It includes the three largest cryptocurrencies, plus Crumbs native currency, Metal.”
v. “HODL—This portfolio is split between bitcoin and Ether, the native asset of Ethereum, a decentralized platform for applications. These are the top two cryptocurrencies in terms of market cap.”
vi. “Moon—This portfolio is half bitcoin and the other half split between Ether and Ripple, the native asset of the Ripple network and a distributed open-source payments system. These are the top three cryptocurrencies in terms of market cap.”
vii. “Taste of Crypto—This is a market cap weighted index containing all Crumbs supported cryptocurrencies and is automatically rebalanced.” (screenshot displayed in FIG. 1)
   We understand that FIG. 1 from the Crumbs app refers to the following cryptocurrencies:
Bitcoin—67%
Ethereum—16%
Ripple—6%
Bitcoin Cash—5%
EOS—2% (black logo)
Stellar—2% (aqua blue logo)
Litecoin—1% (green logo)
Metal—1% (purple logo)

As part of the signup process for the Crumbs app, users agree and acknowledge the following:
“I authorize Crumbs to debit my linked account for the recurring round-up payments.”
“By creating this account you agree to our financial software partner Synapse's Terms of Service and Privacy Policy.”
“I have reviewed Crumbs fee structure as follows: roundups and recurring buys have a fee that is 2% of the total transaction amount, buys and sells have a variable fee which will be displayed before confirming order, and deposits/withdrawals have no fee.”
“Withdrawal fees are $0.10 per transaction.”

The Crumbs app uses Plaid to connect a user's bank account. The app also allows a user to link a credit card to “stack your round ups quicker.”

The Crumbs app displays news articles about cryptocurrency and the app displays cryptocurrency prices under the “DISCOVER” tab/screen. The app allows a view of a user's Crumbs account balance. The “HISTORY” screen displays a dollar amount as the “TOTAL INVESTED.” Under “SETTINGS” the user can see “Investment Preferences” and the subheadings “Portfolio” and “Manage Investments.”

Metallicus, Inc. views the Crumbs app as allowing a user to invest fiat currency into cryptocurrency, similar to how Acorns (ww.acorns.com) allows users to invest in a more traditional securities portfolio. The company intends to allow users to choose from pre-defined cryptocurrency portfolios that automatically adjust and to allow users to regular investments (weekly, monthly etc.). The Crumbs app is intended to provide users with the experience of wallet functionality since a user does not need to handle private keys or otherwise worry about custody or security of the purchased cryptocurrencies. Of course, we assume based on Metallicus, Inc.'s representations that the actual exchange of cryptocurrency for fiat or other cryptocurrencies is being done by the third party exchanges.

The company desires to selectively add additional cryptocurrencies to the investment options it provides to its users through the Crumbs app. This agreement may be called a “Partication Agreement” or another name to be determined.

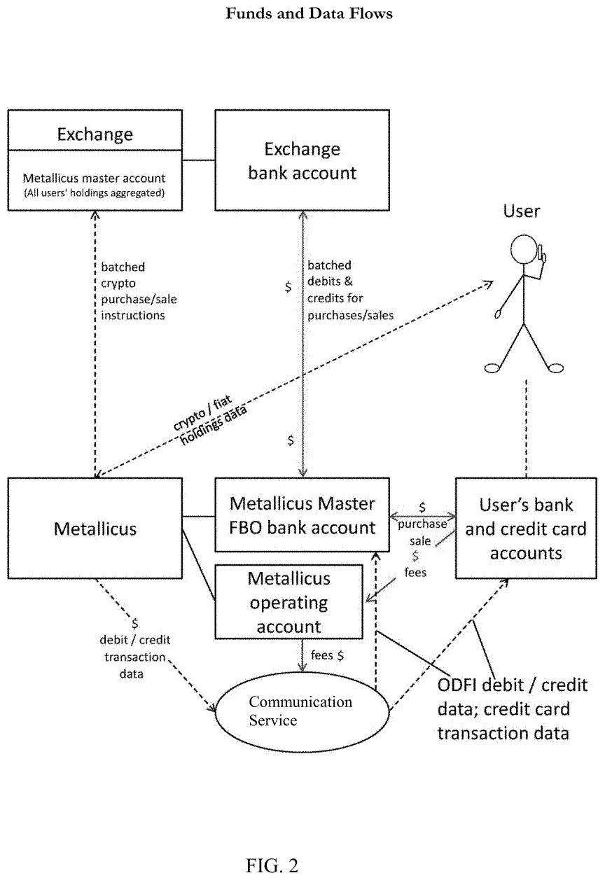

Current funds flow and structure—Our understanding of the overall funds and data flow is set forth in FIG. 2. We understand that Metallicus, Inc. has a master FBO account at Bank & Trust which is titled in Metallicus' name for the benefit of its users. Financial Technologies, Inc. (“FI”) acts as agent for the bank and maintains a ledger showing the amount held for the benefit of each user in that master account. Depending on the state in which a user resides, FI may maintain a deposit account at the bank in that user's name.

We further understand that Metallicus, Inc. has a master account at each of the exchanges/wallets with which the company does business, including Binance. Those master accounts are owned and controlled by Metallicus, Inc. but all cryptocurrency in the master accounts is held for the benefit of users.

The company updates information in the apps on a real-time basis so the user feels that transactions happen instantly even though the clearing in the company's master FBO bank account and master exchange accounts can take up to 5 days. Also, the company is able to allow any given user to withdraw fiat currency from the company's master bank account prior to actual settlement since the large balance in the master account provides ample liquidity to cover withdrawals at any given moment. The company does not charge any fee if it transfers funds to a user prior to clearing the transaction giving rise to the funds transfer.

Metallicus, Inc. sees itself as acting similar to a payment facilitator with respect to the third party cryptocurrency exchanges/wallets since they bring fiat currency to the exchanges. This is referred to as the “fiat on ramp and off ramp.” This is a valuable service from the exchanges' perspective since some cryptocurrencies cannot be purchased directly with fiat currency.

Metallicus, Inc. views itself as trying to solve problem of easily knowing who you are sending money to, both in terms of their basic identifying data but also qualitative information such as the Pop score.

Metal Pay Wallet—Metallicus, Inc. plans to offer a proprietary wallet that allows individuals to purchase, store, and transfer fiat currency and cryptocurrency. The company does not itself currently (as of September 2018) operate as a wallet and instead partners with third party wallets and cryptocurrency exchanges to perform those exchange and wallet functions.

Money transmitter licensing—The company is operating in 34 states where the company believes it does not need a money transmitter license in order to operate. Currently, the company relies upon a third party licensed money transmitter to process transfers to and from users' bank accounts.

Metal payment services will be accessed via smart phone application and/or web portal Users may open an individual or a merchant account using any of the above channels.

### BRIEF DESCRIPTION OF THE FIGURES

This disclosure is illustrated by way of example and not limitation in the figures of the accompanying drawings, in which like references indicate similar elements, and in which:

Scenarios:

### Wallet Funding

S1→Virtual currency funded from user's own outside source
S2→Virtual currency funded with fiat from linked card
S3→Virtual currency funded with fiat from linked from linked bank account

### P2P Transfers

S4→Virtual currency transfer funded from existing wallet balance
S5→Fiat transfer funded from linked card
S6→Fiat transfer funded from existing wallet balance
S7→Fiat transfer funded from linked bank account

### P2B Payments

S8→with virtual currency funded from wallet balance
S9→with fiat funded from linked card
S10→with fiat funded from existing wallet balance
S11→with fiat funded from linked bank account
S12→with linked card product funded by existing wallet fiat balance

FIG. 1 displays a screenshot illustrating an exemplary application that includes a portfolio of cryptocurrency assets.

FIG. 2 displays a block diagram showing flow of data between a user's mobile device, an application utilizing a proof of payment protocol, and various servers, in accordance with an exemplary embodiment.

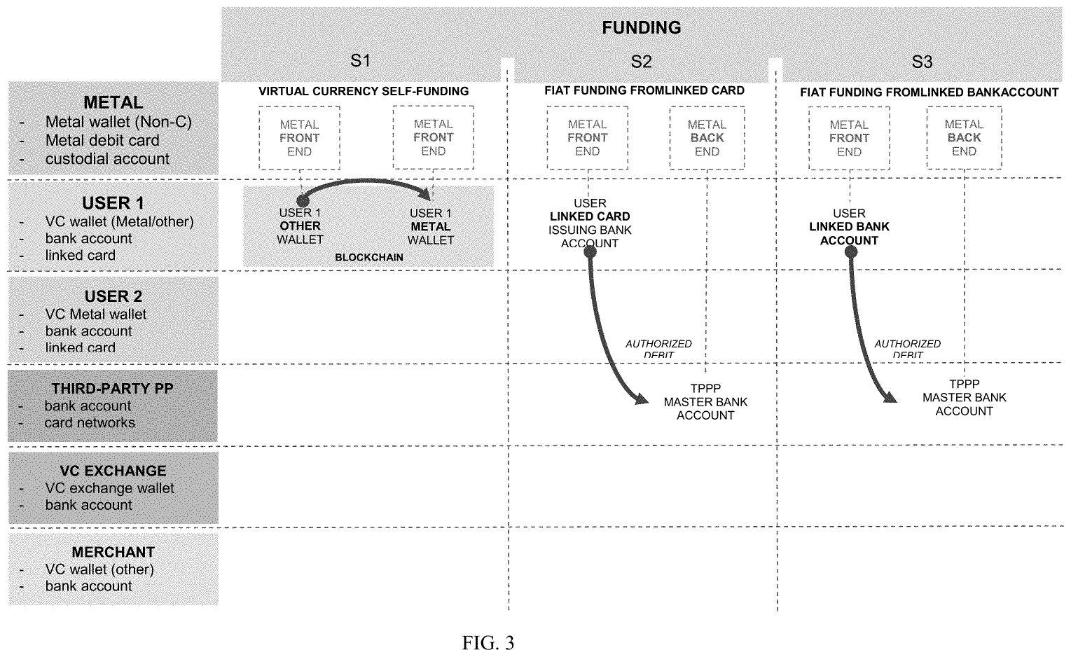

FIG. 3 shows a line diagram displaying various data transfer scenarios, according to an exemplary embodiment.

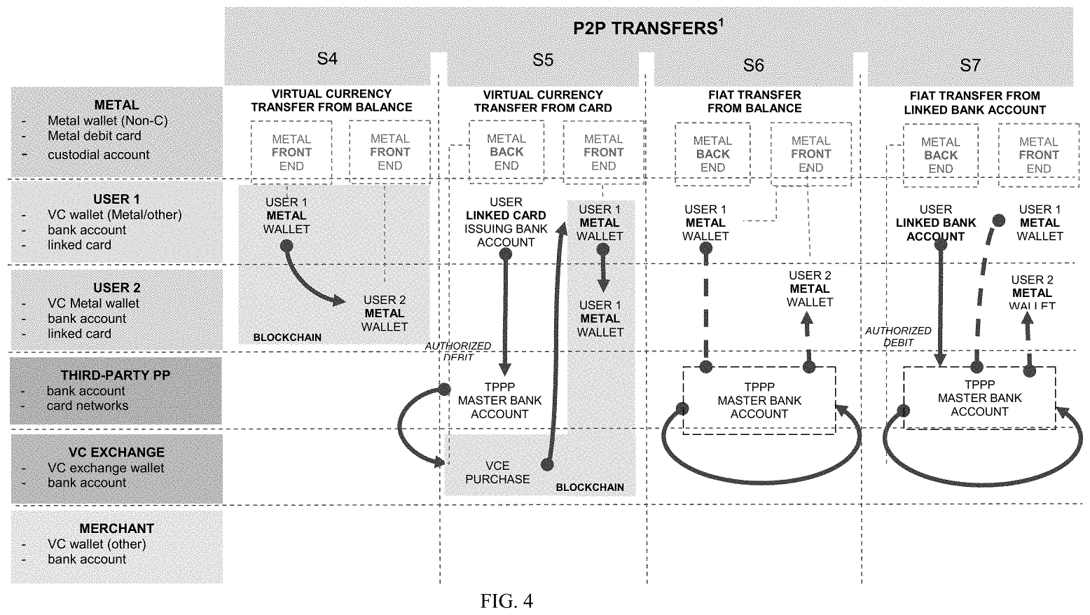

FIG. 4 shows a line diagram displaying various peer-to-peer transfer scenarios, according to an exemplary embodiment.

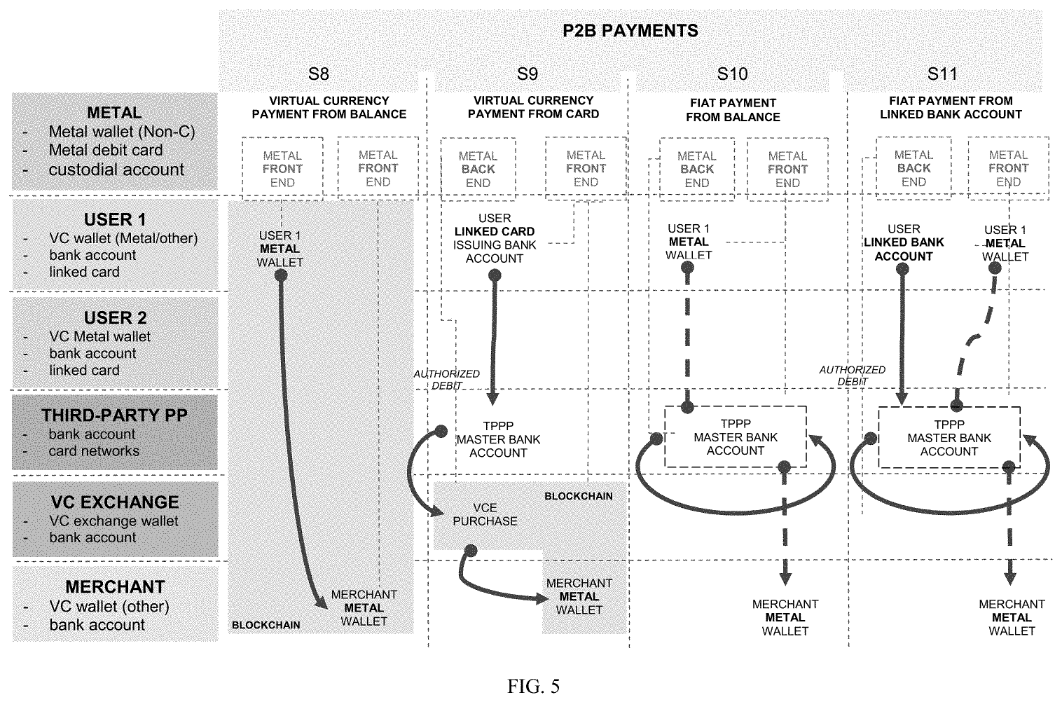

FIG. 5 shows a line diagram displaying various P2B transfer scenarios, according to an exemplary embodiment.

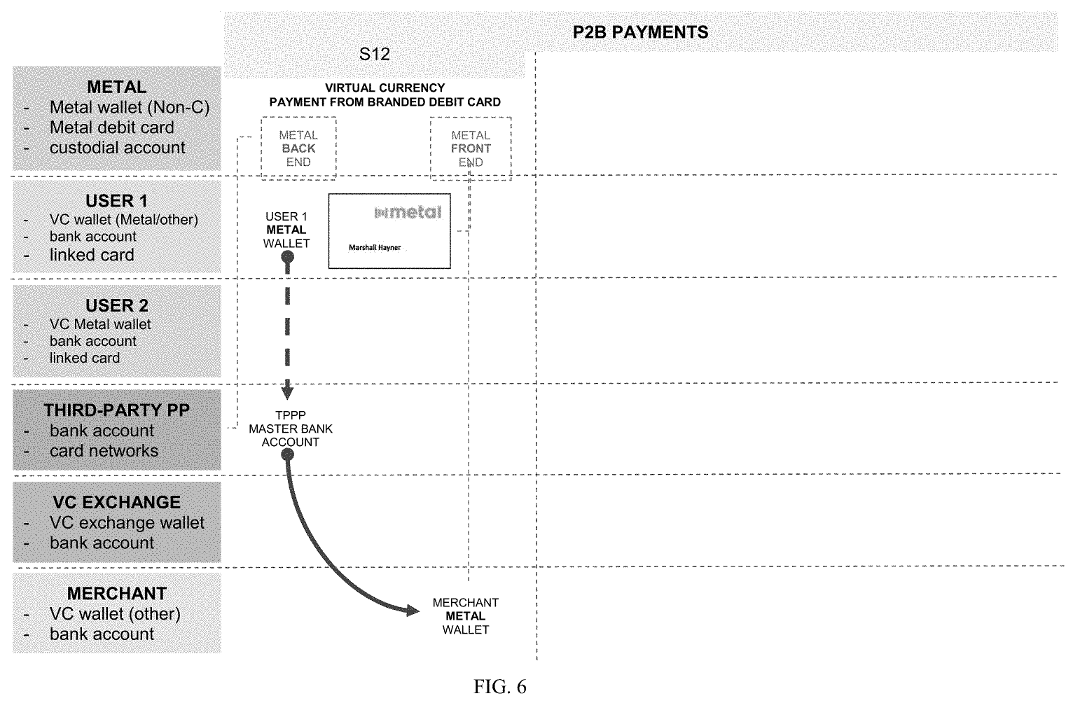

FIG. 6 shows a line diagram displaying a P2B transfer scenario, according to an exemplary embodiment.

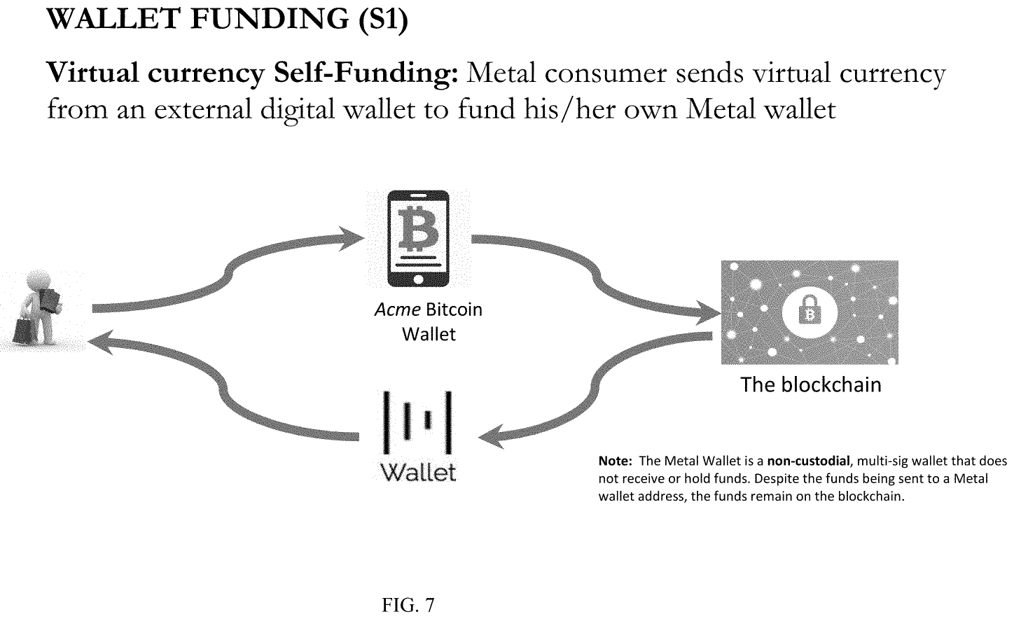

FIG. 7 shows a block diagram displaying a data transfer scenario within a single user's data wallet, according to an exemplary embodiment.

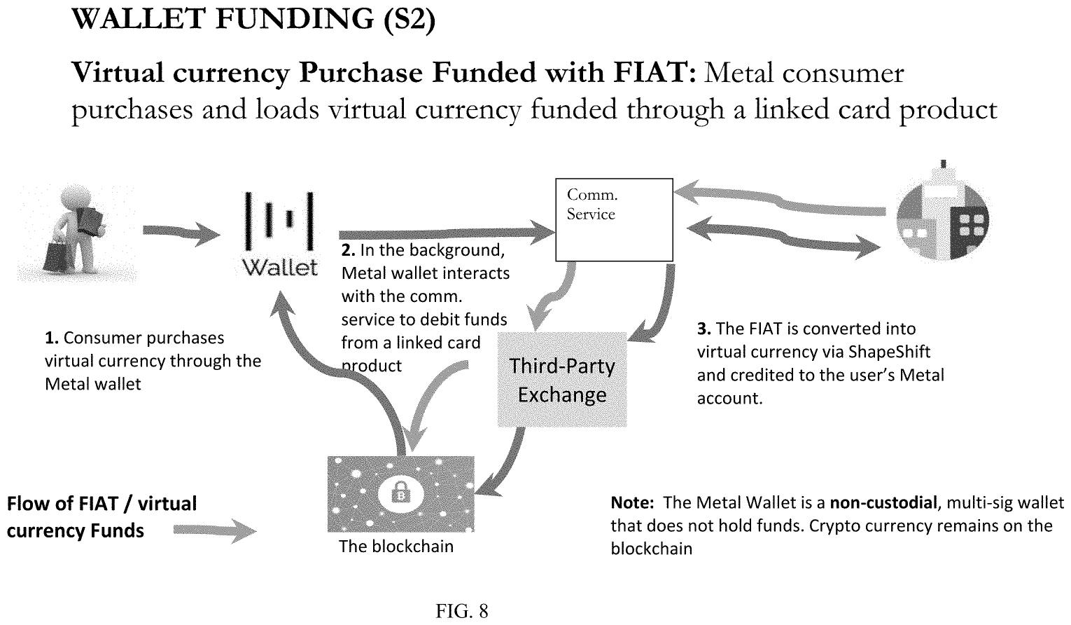

FIG. 8 shows a block diagram displaying a data transfer scenario within a single user's data wallet, according to an exemplary embodiment.

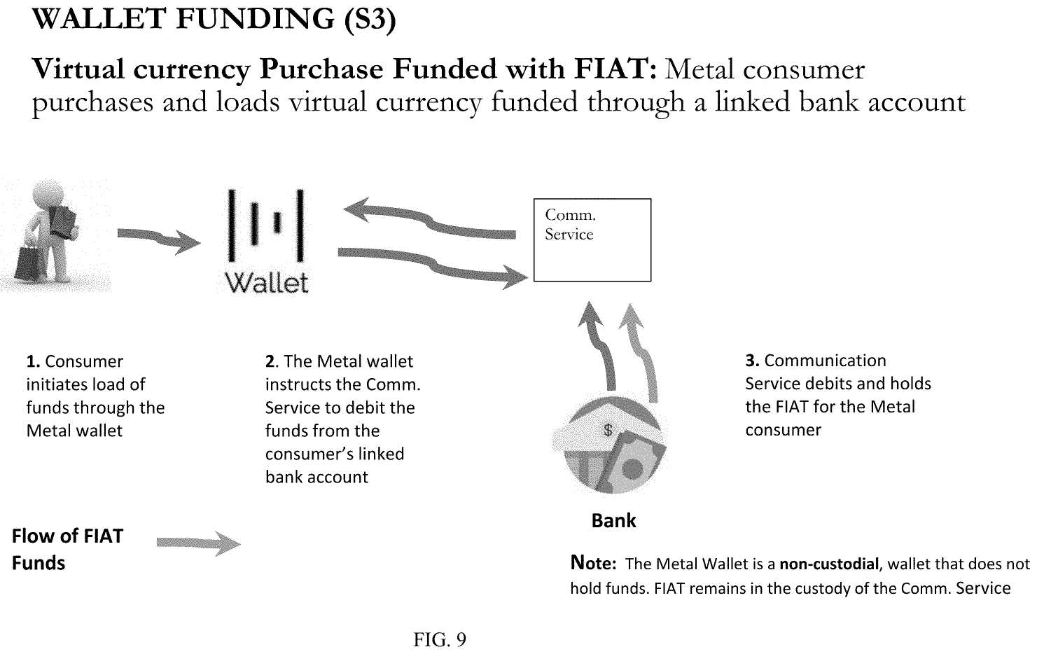

FIG. 9 shows a block diagram displaying a data transfer scenario within a single user's data wallet, according to an exemplary embodiment.

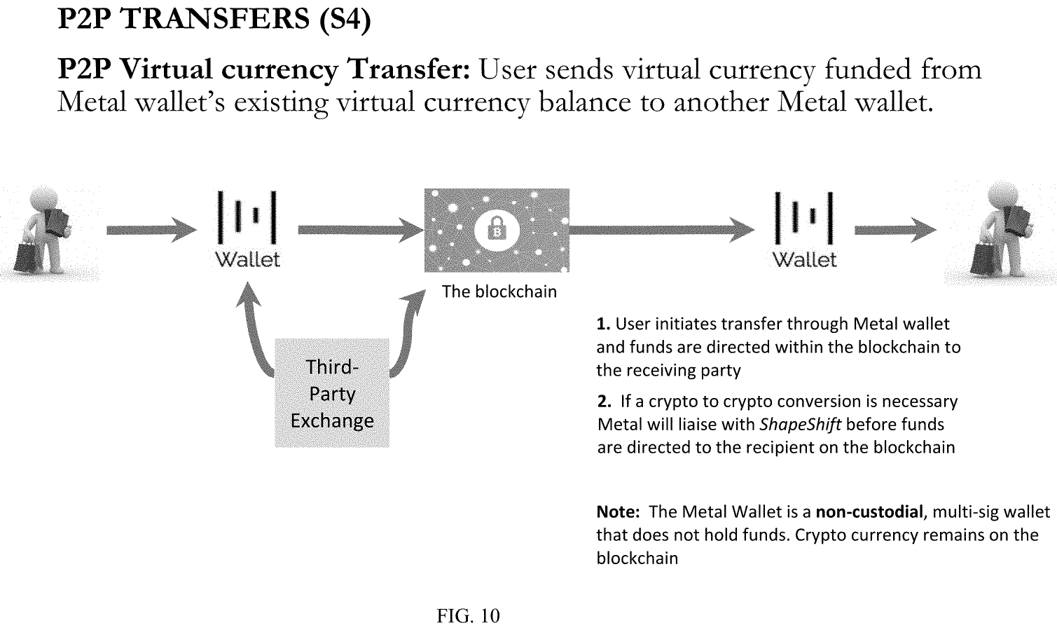

FIG. 10 shows a block diagram displaying a data transfer scenario from one user's data wallet to the data wallet of another user, according to an exemplary embodiment.

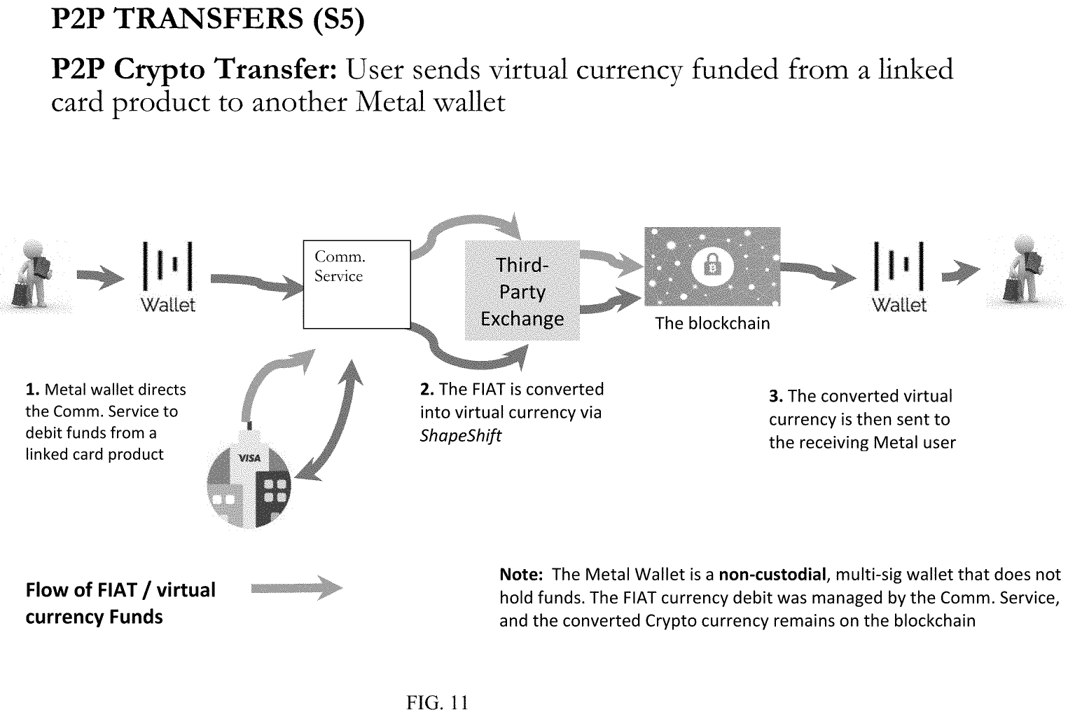

FIG. 11 shows a block diagram displaying a data transfer scenario from one user's data wallet to the data wallet of another user, according to an exemplary embodiment.

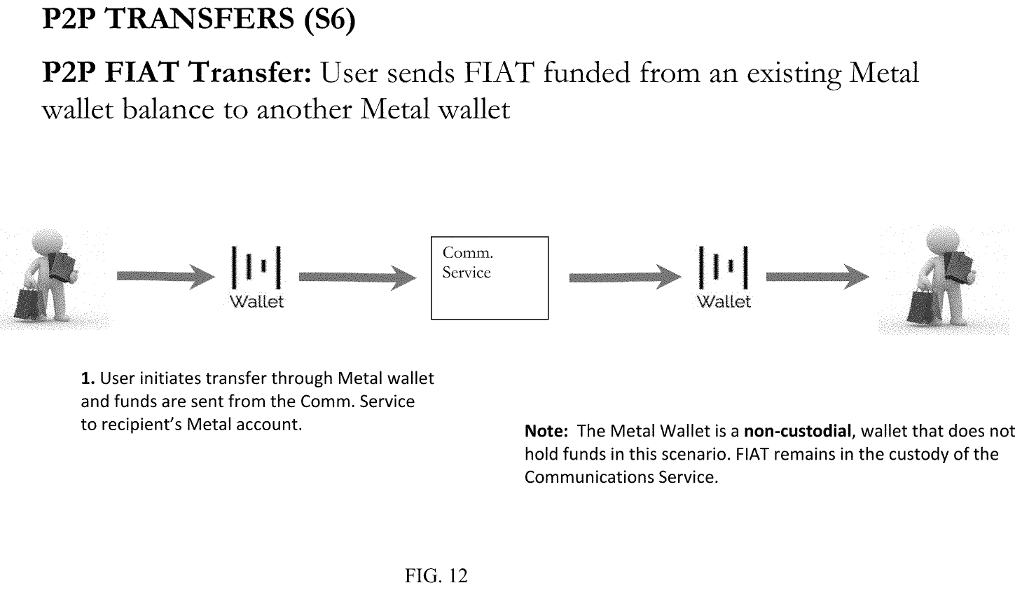

FIG. 12 shows a block diagram displaying a data transfer scenario from one user's data wallet to the data wallet of another user, according to an exemplary embodiment.

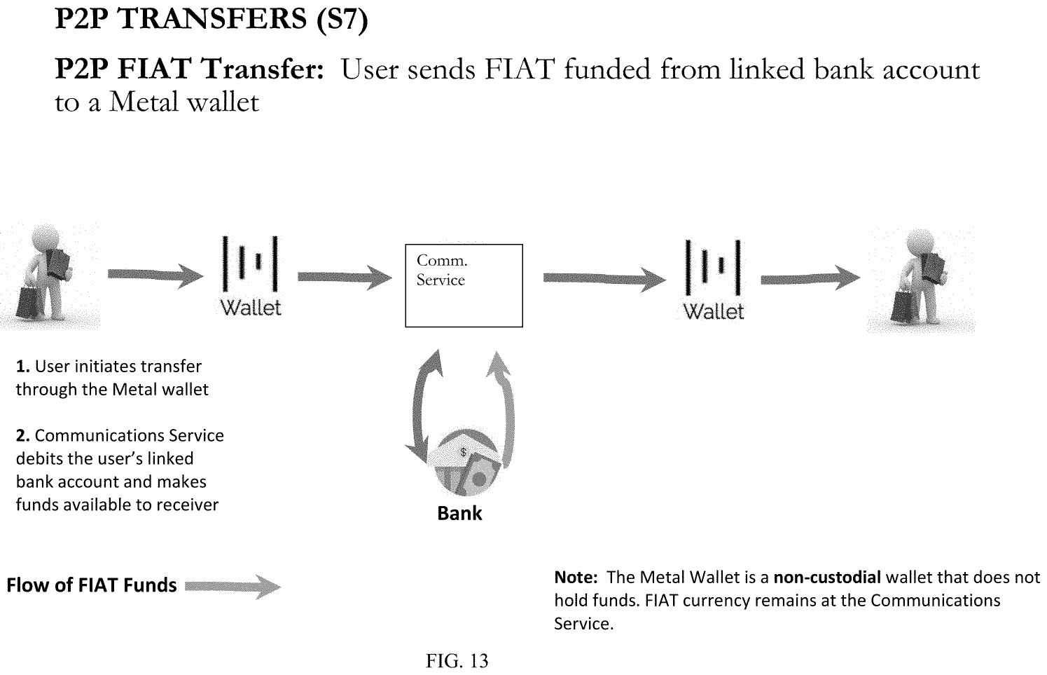

FIG. 13 shows a block diagram displaying a data transfer scenario from one user's data wallet to the data wallet of another user, according to an exemplary embodiment.

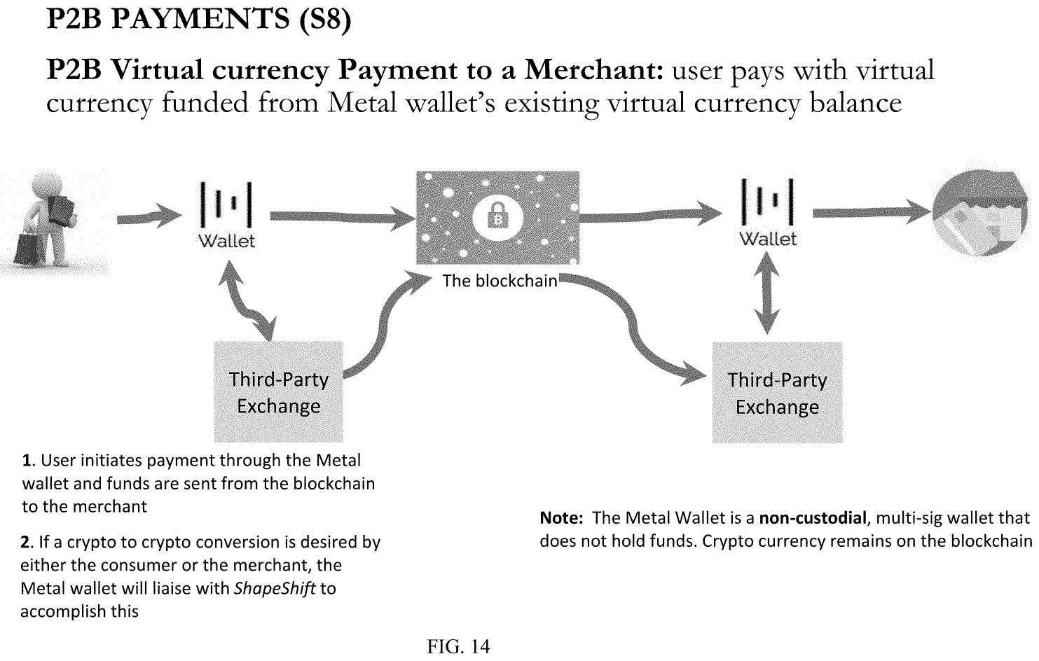

FIG. 14 shows a block diagram displaying a data transfer scenario from one user's data wallet to the data wallet of a merchant, according to an exemplary embodiment.

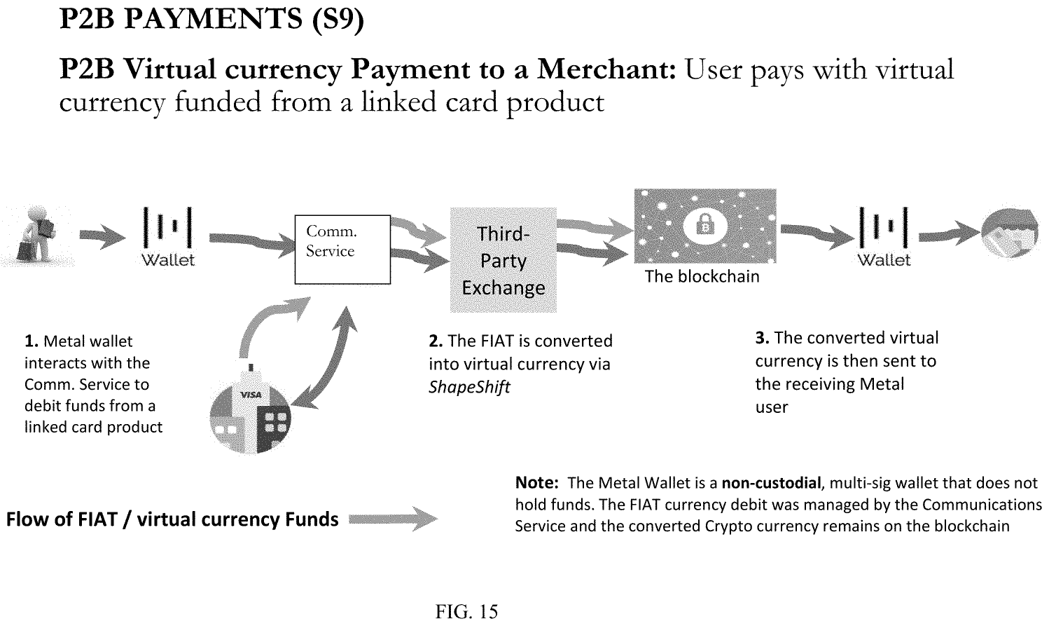

FIG. 15 shows a block diagram displaying a data transfer scenario from one user's data wallet to the data wallet of a merchant, according to an exemplary embodiment.

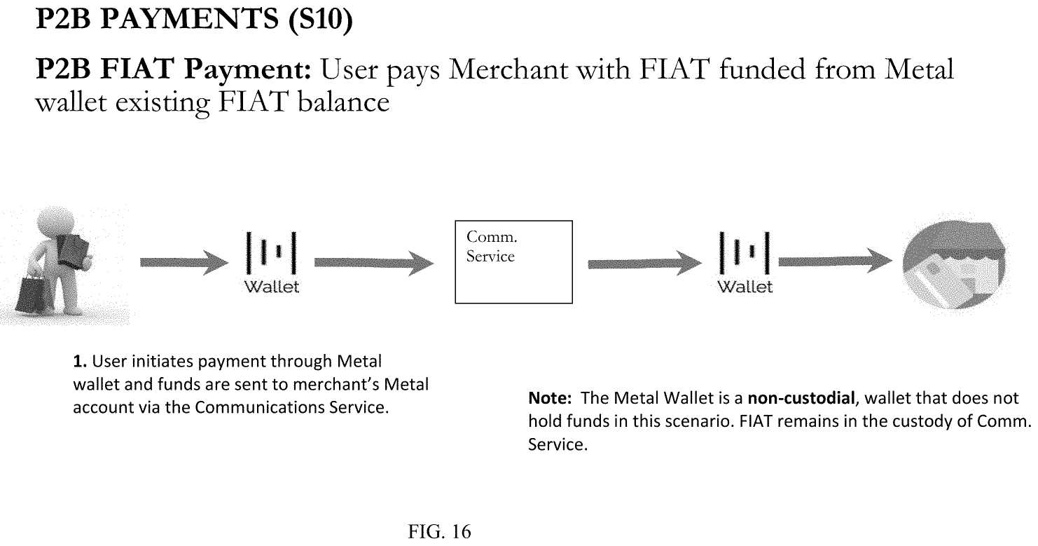

FIG. 16 shows a block diagram displaying a data transfer scenario from one user's data wallet to the data wallet of a merchant, according to an exemplary embodiment.

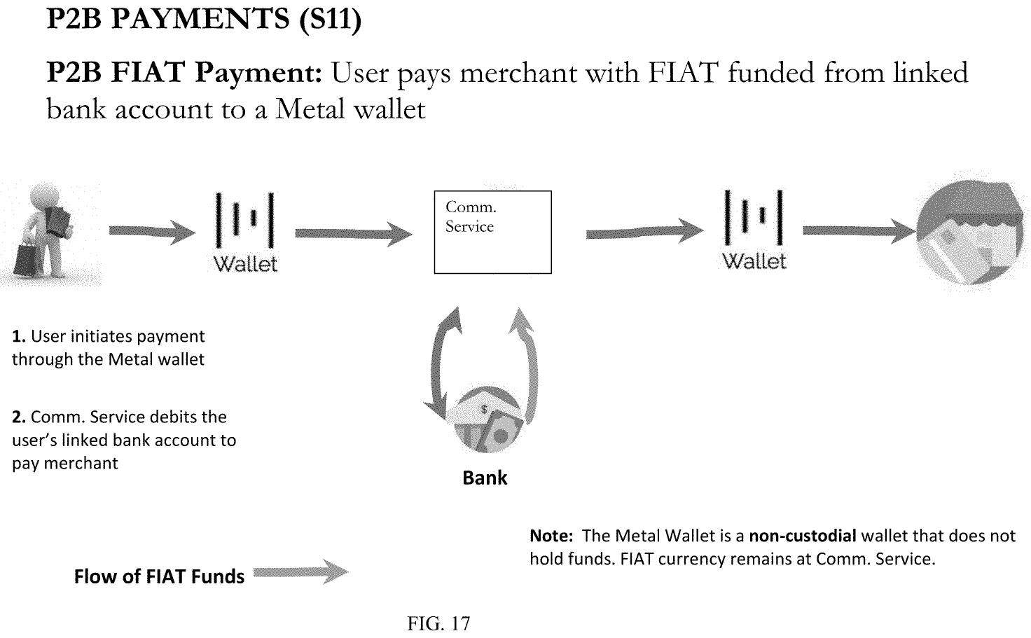

FIG. 17 shows a block diagram displaying a data transfer scenario from one user's data wallet to the data wallet of a merchant, according to an exemplary embodiment.

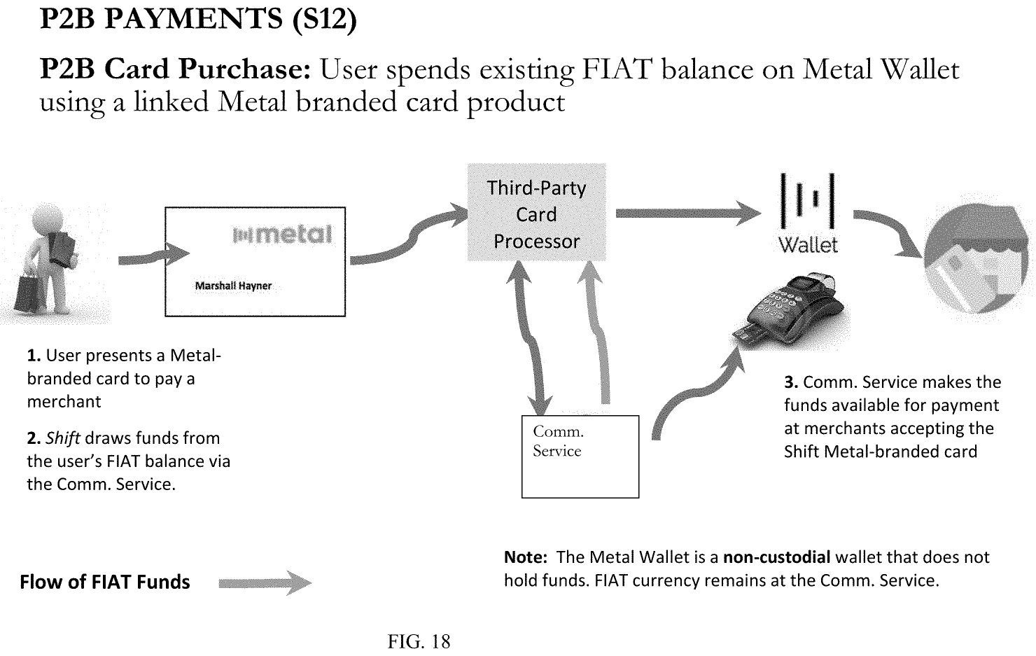

FIG. 18 shows a block diagram displaying a data transfer scenario from one user's data wallet to the data wallet of a merchant, according to an exemplary embodiment.

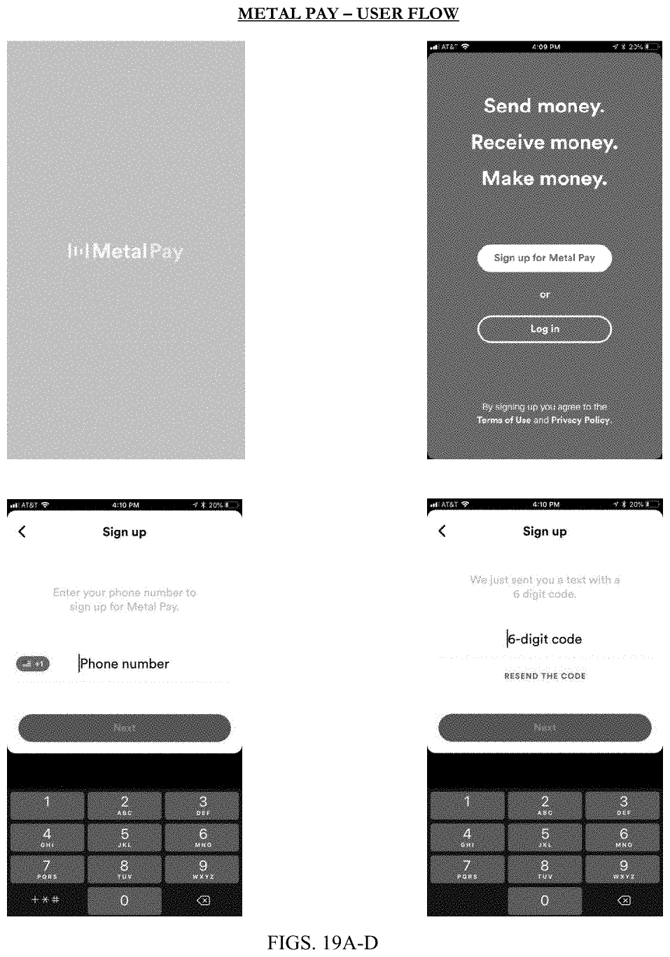

FIGS. 19A-D display screenshots illustrating user setup of an account, in accordance with an exemplary embodiment.

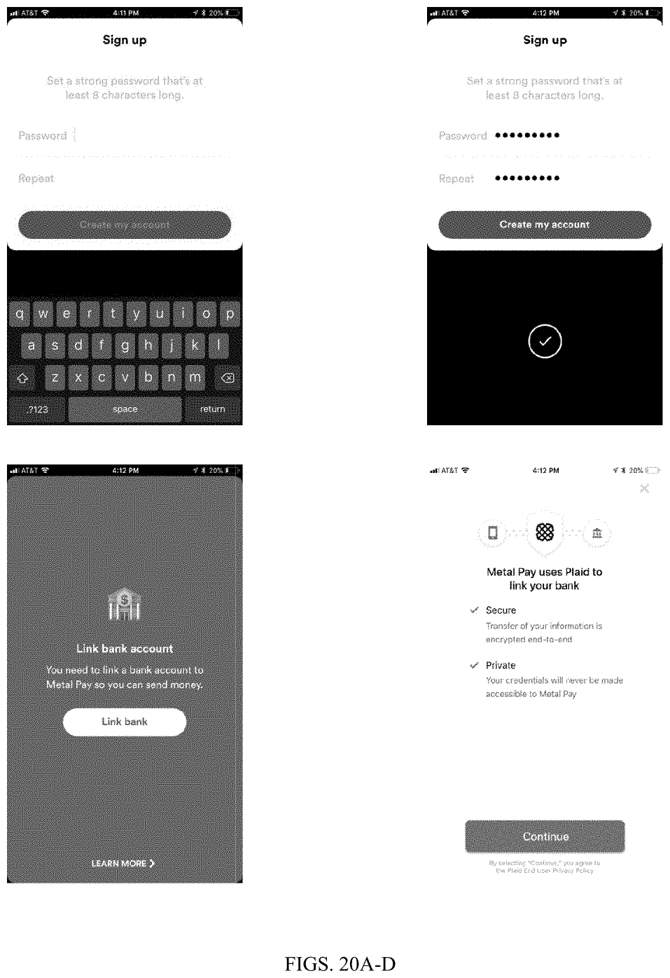

FIGS. 20A-D display screenshots illustrating user setup of an account, in accordance with an exemplary embodiment.

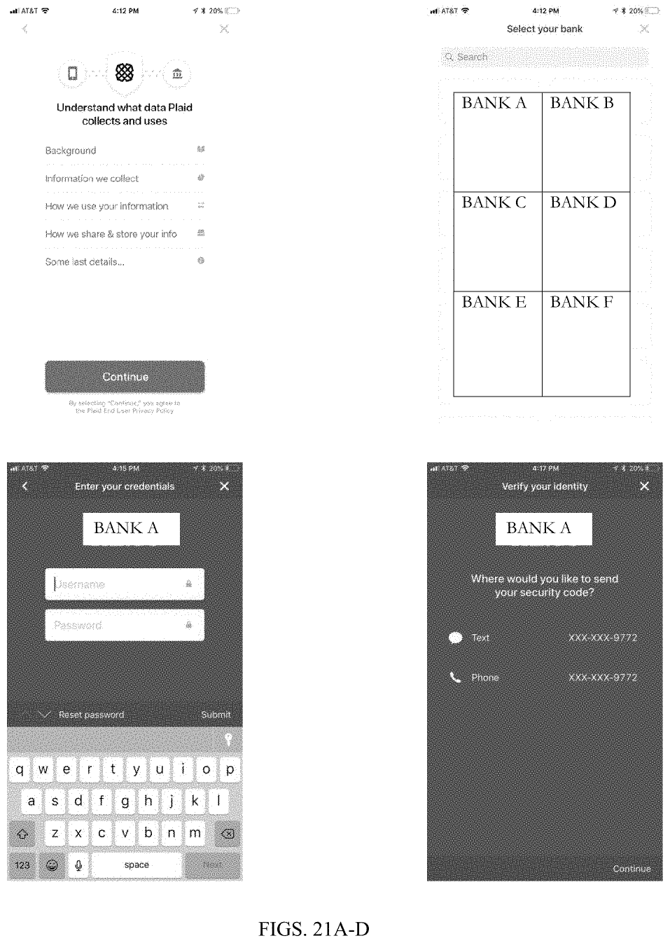

FIGS. 21A-D display screenshots illustrating user setup of an account, in accordance with an exemplary embodiment.

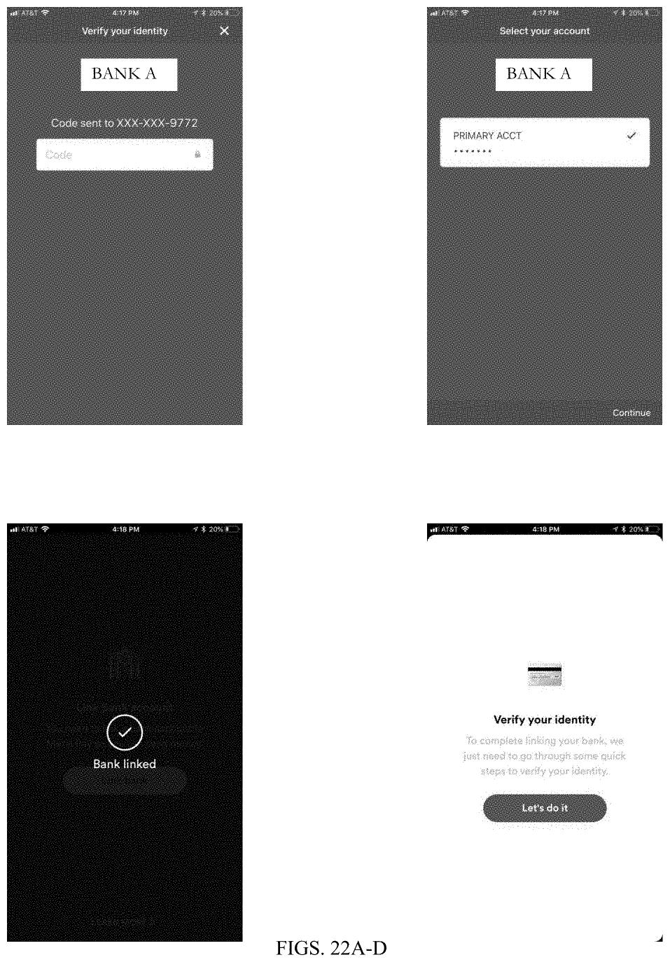

FIGS. 22A-D display screenshots illustrating user setup of an account, in accordance with an exemplary embodiment.

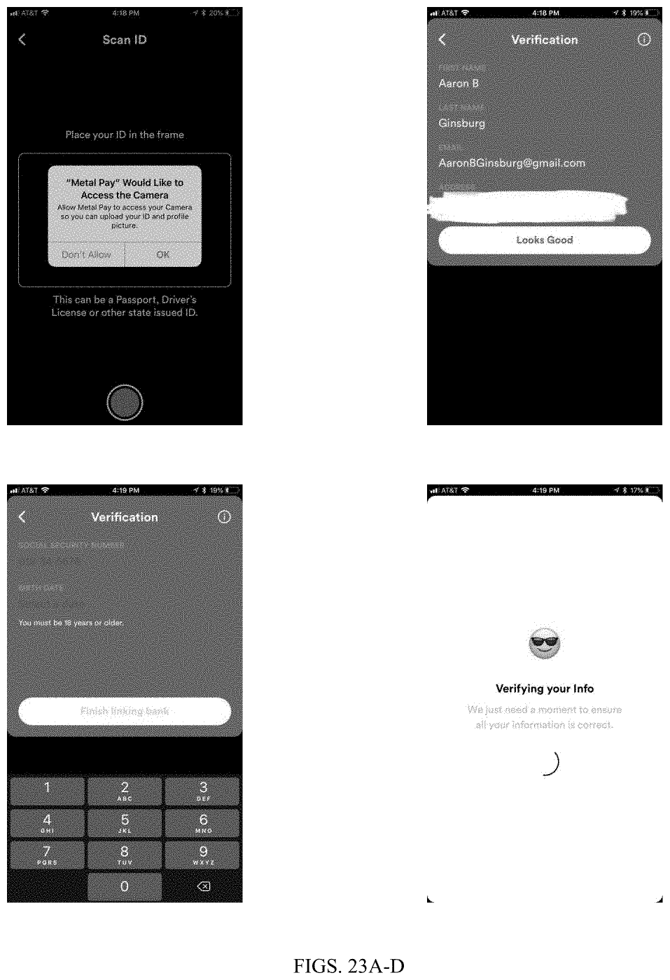

FIGS. 23A-D display screenshots illustrating user setup of an account, in accordance with an exemplary embodiment.

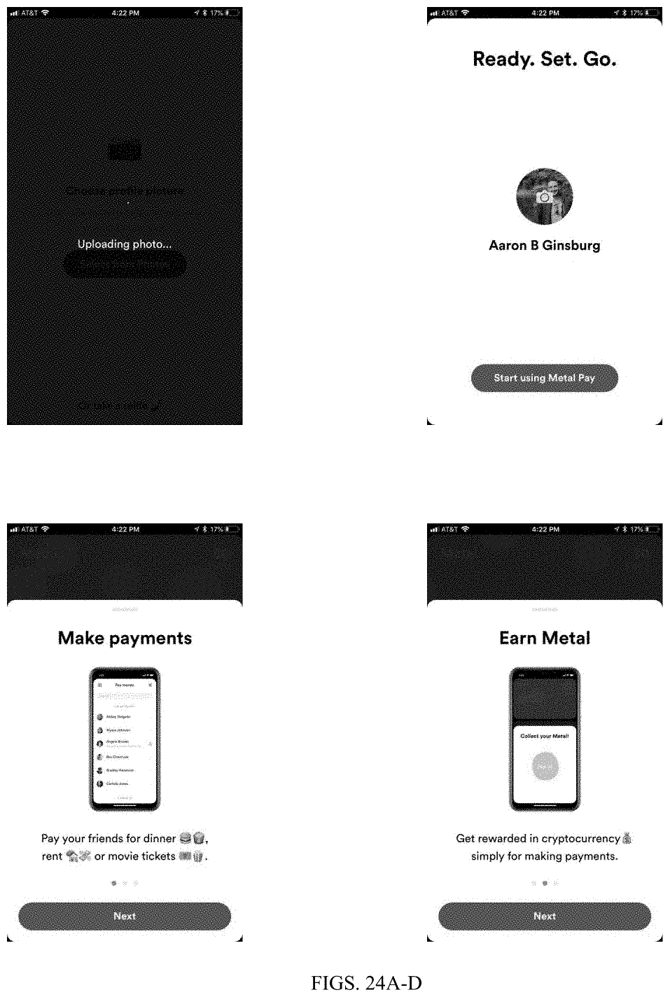

FIGS. 24A-D display screenshots illustrating various user interfaces of an application for distributing a cryptocurrency using a distribution system, in accordance with an exemplary embodiment.

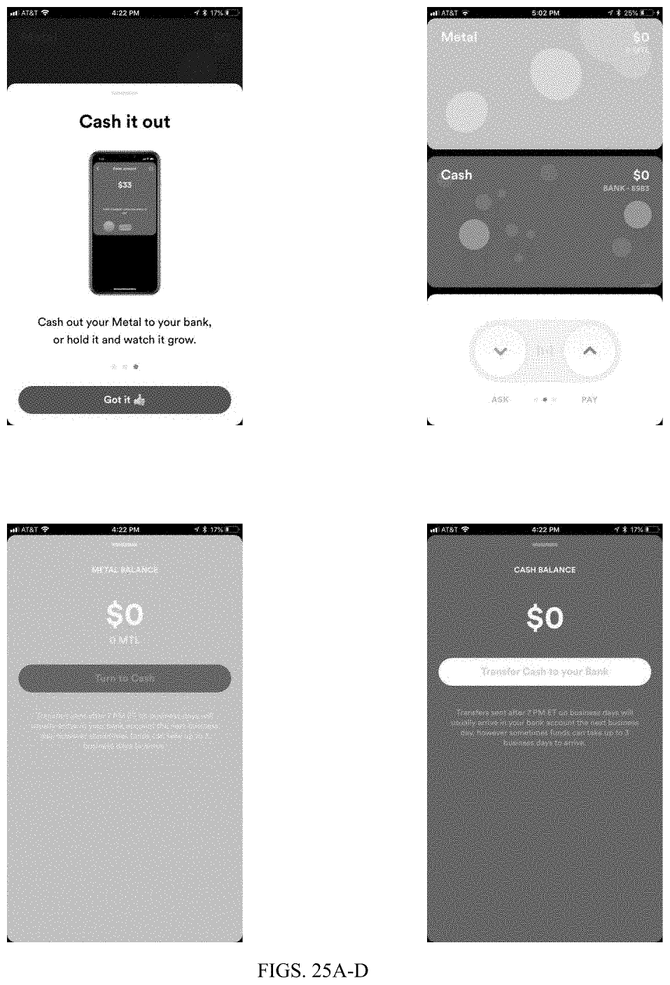

FIGS. 25A-D display screenshots illustrating various user interfaces of an application for distributing a cryptocurrency using a distribution system, in accordance with an exemplary embodiment.

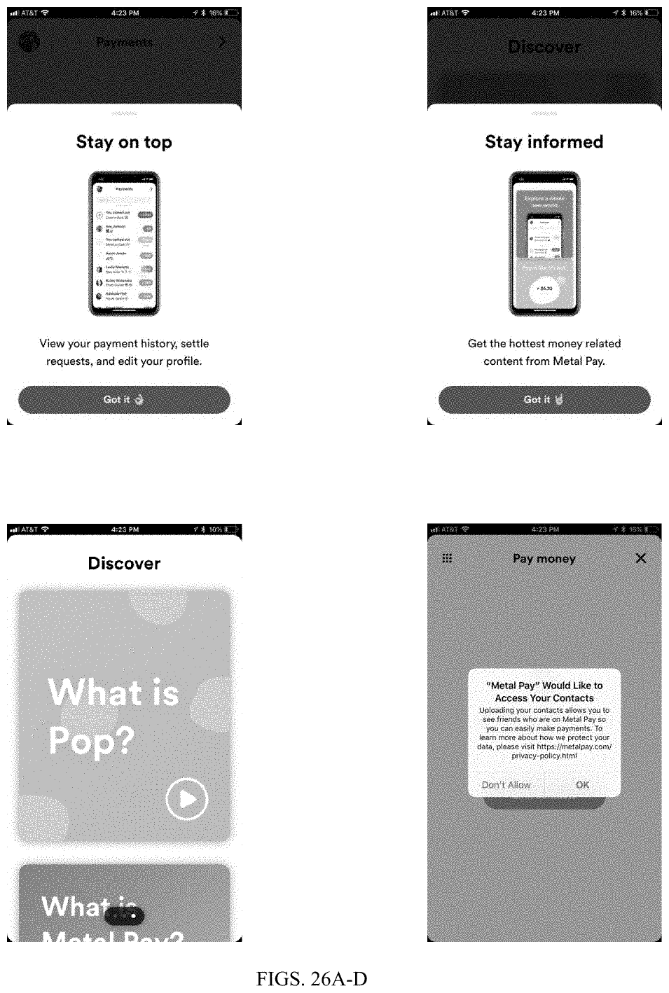

FIGS. 26A-D display screenshots illustrating various user interfaces of an application for distributing a cryptocurrency using a distribution system, in accordance with an exemplary embodiment.

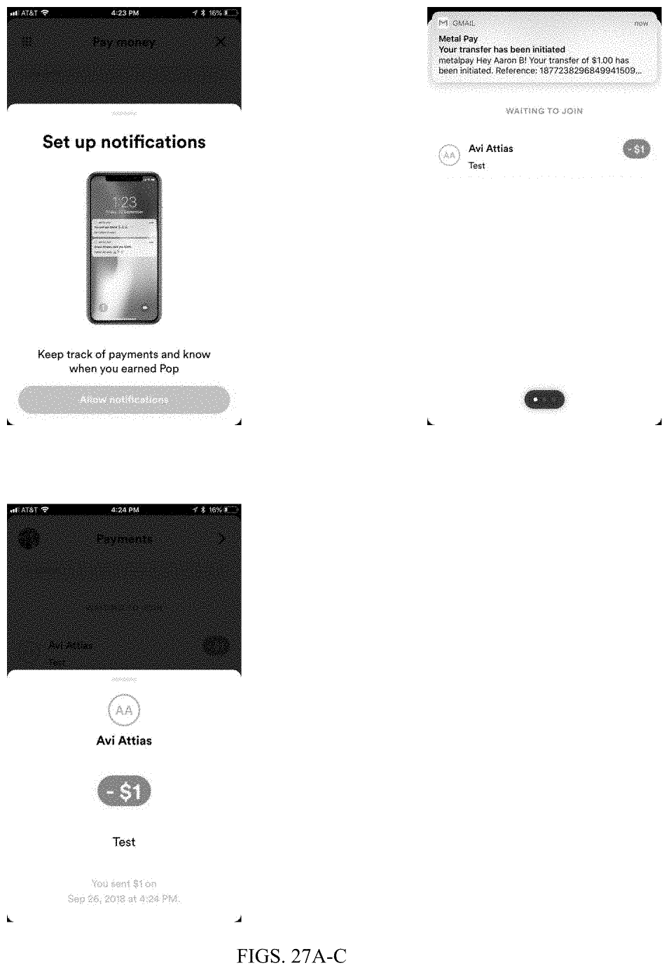

FIGS. 27A-C display screenshots illustrating user interfaces of setting up notifications for transferring cryptocurrency using an application for distributing a cryptocurrency using a distribution system, in accordance with an exemplary embodiment.

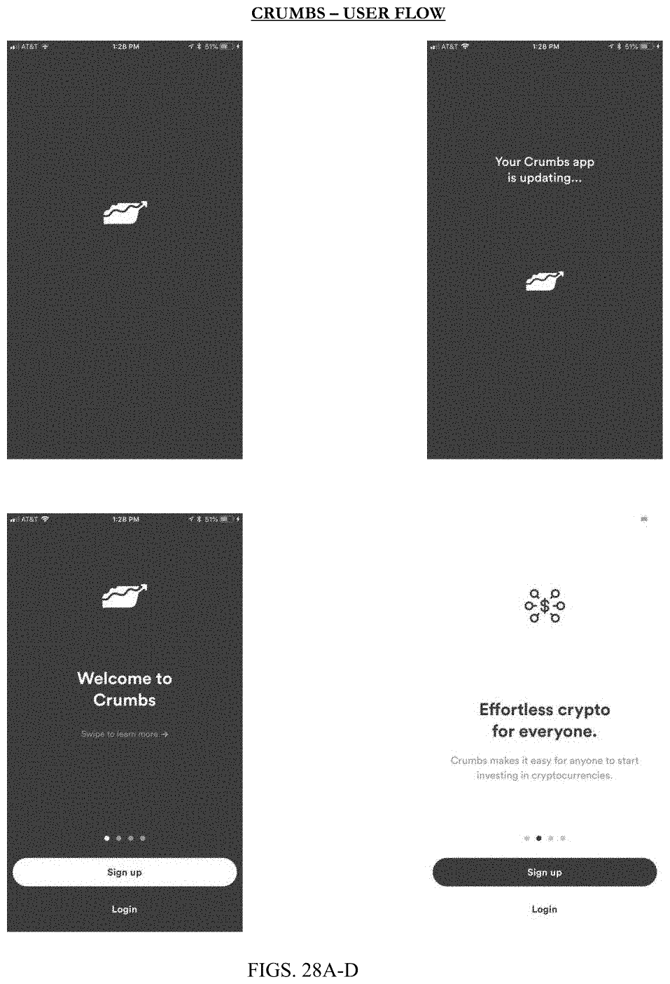

FIGS. 28A-D display screenshots illustrating various user interfaces of an application for distributing a cryptocurrency using a distribution system, in accordance with an exemplary embodiment.

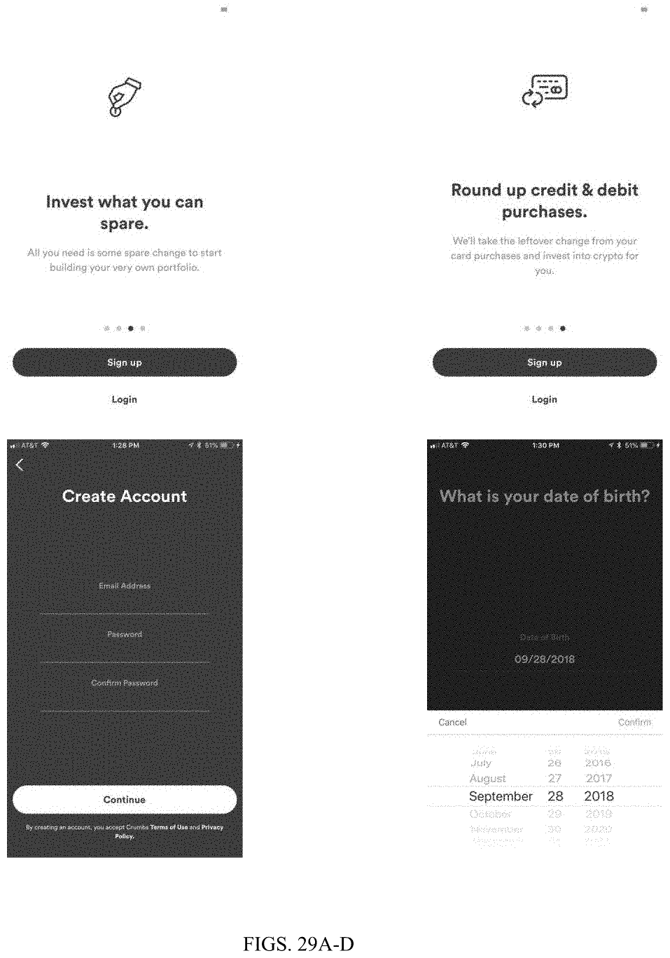

FIGS. 29A-D display screenshots illustrating various user interfaces for setting up an application for distributing a cryptocurrency using a distribution system, in accordance with an exemplary embodiment.

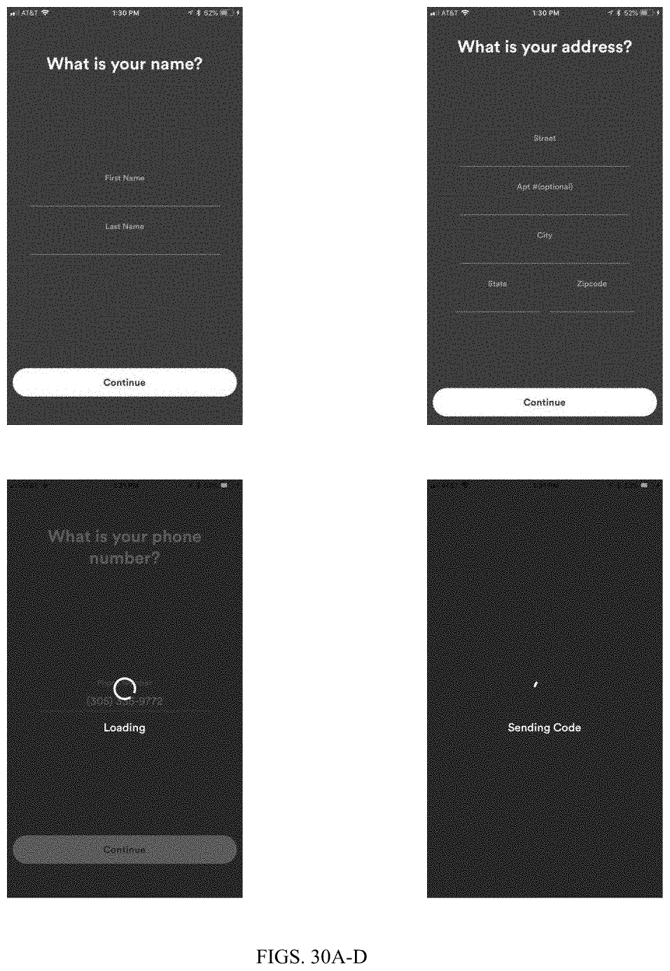

FIGS. 30A-D display screenshots illustrating various user interfaces for setting up an application for distributing a cryptocurrency using a distribution system, in accordance with an exemplary embodiment.

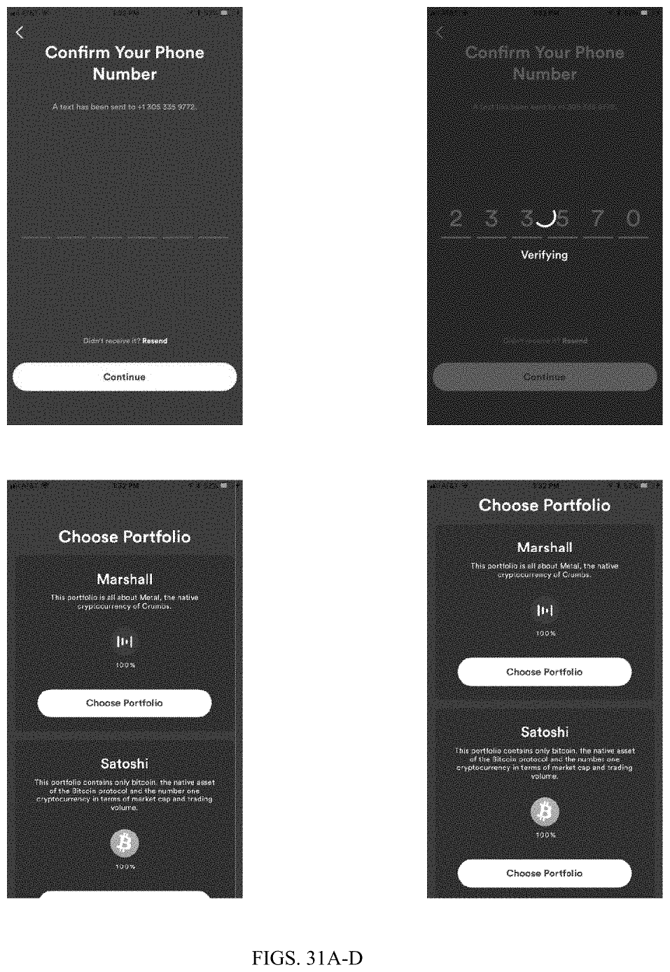

FIGS. 31A-D display screenshots illustrating various user interfaces for setting up an application for distributing a cryptocurrency using a distribution system, in accordance with an exemplary embodiment.

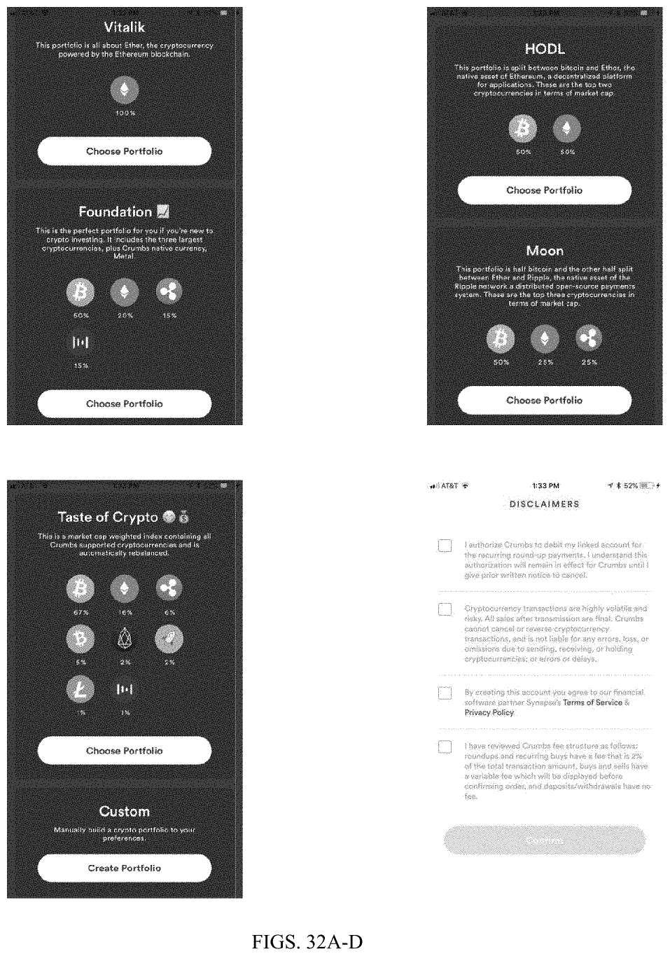

FIGS. 32A-D display screenshots illustrating various user interfaces for setting up an application for distributing a cryptocurrency using a distribution system, in accordance with an exemplary embodiment.

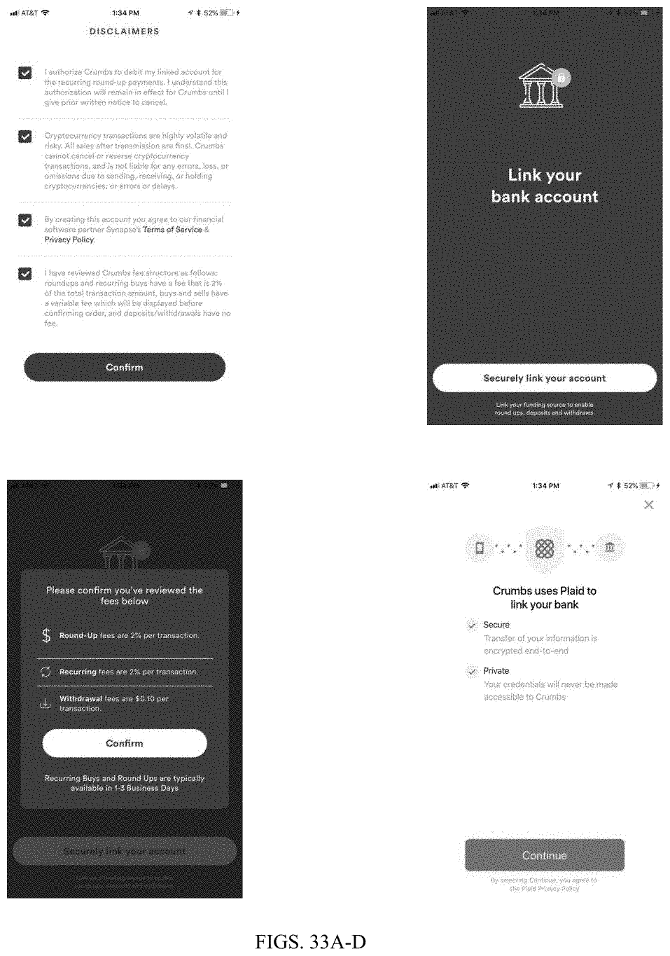

FIGS. 33A-D display screenshots illustrating various user interfaces for setting up an application for distributing a cryptocurrency using a distribution system, in accordance with an exemplary embodiment.

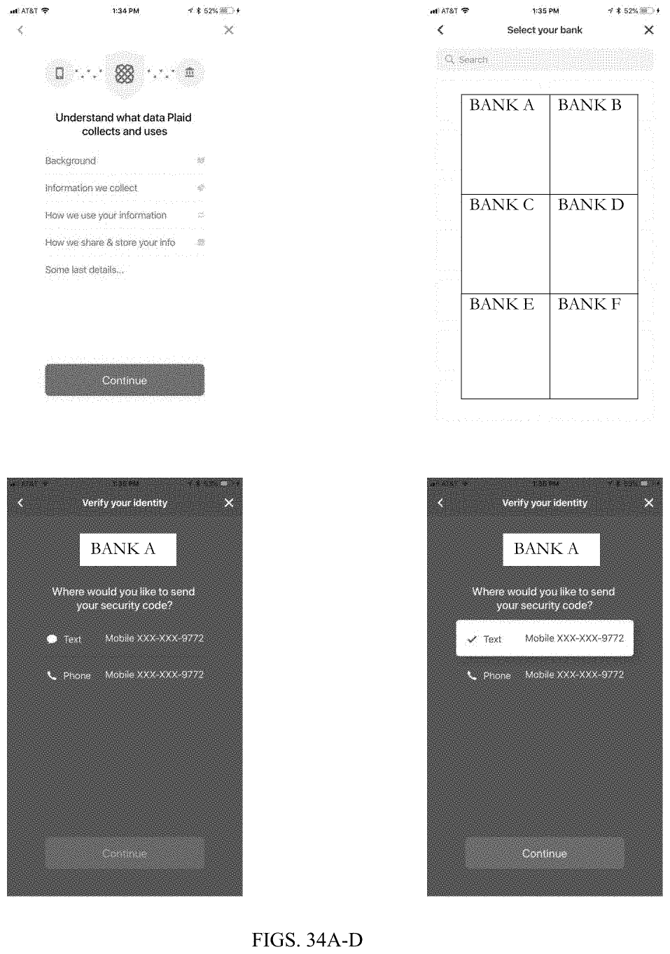

FIGS. 34A-D display screenshots illustrating various user interfaces for setting up an application for distributing a cryptocurrency using a distribution system, in accordance with an exemplary embodiment.

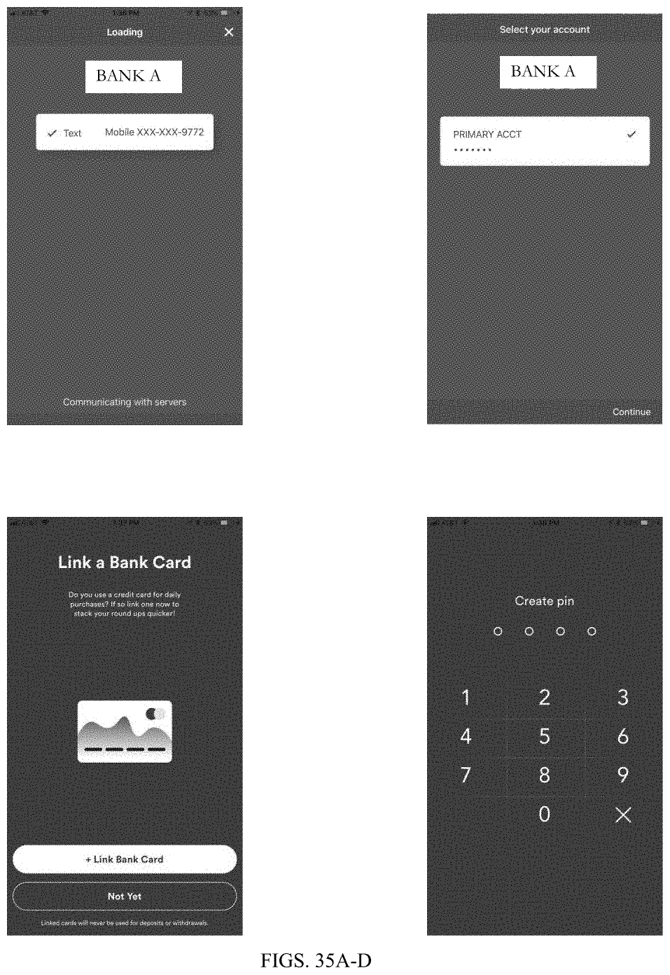

FIGS. 35A-D display screenshots illustrating various user interfaces for setting up an application for distributing a cryptocurrency using a distribution system, in accordance with an exemplary embodiment.

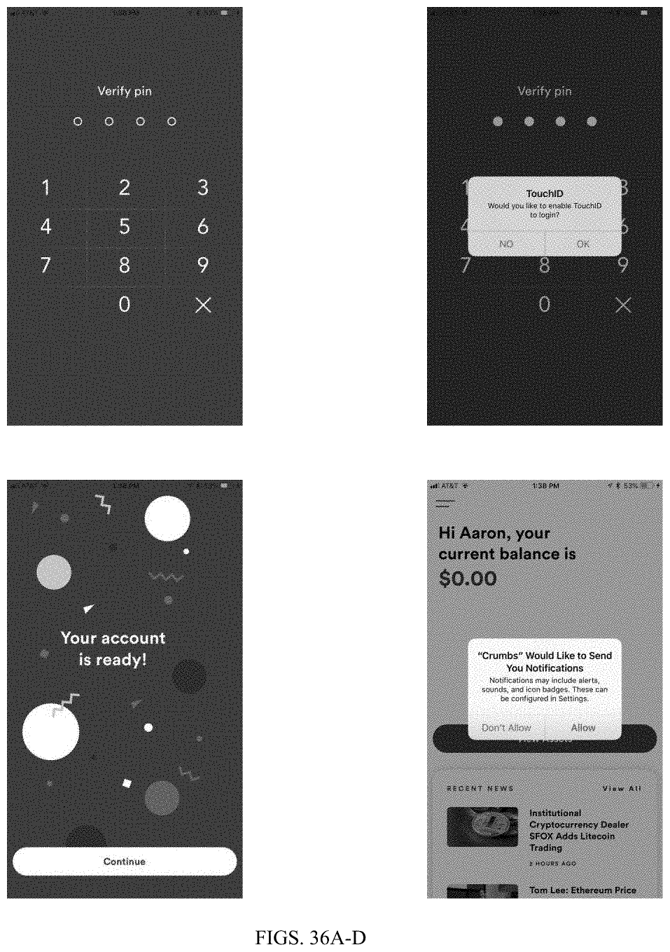

FIGS. 36A-D display screenshots illustrating various user interfaces for setting up an application for distributing a cryptocurrency using a distribution system, in accordance with an exemplary embodiment.

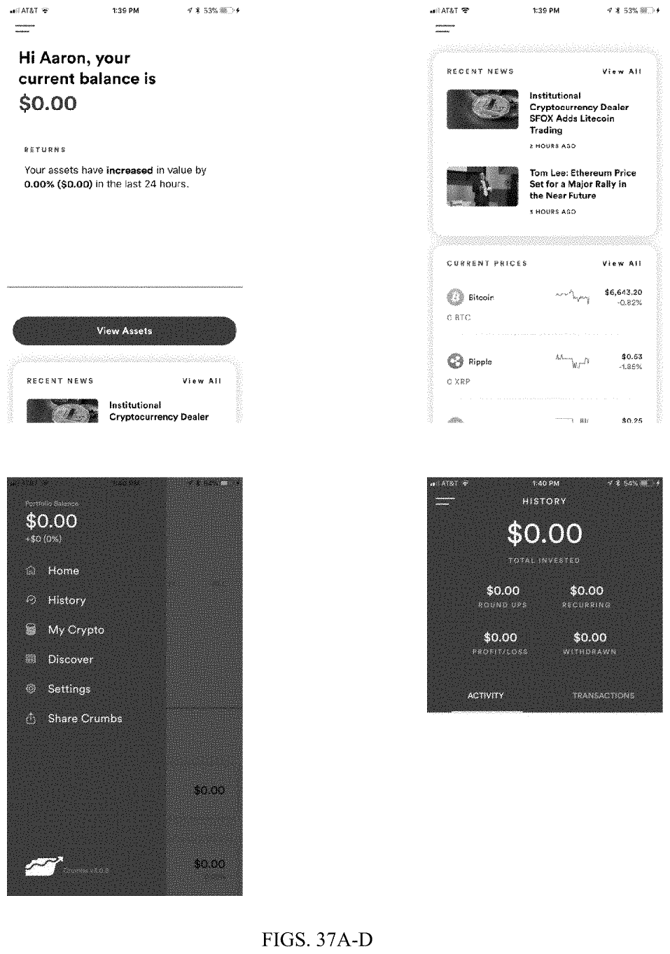

FIGS. 37A-D display screenshots illustrating various user interfaces of an application for distributing a cryptocurrency using a distribution system, in accordance with an exemplary embodiment.

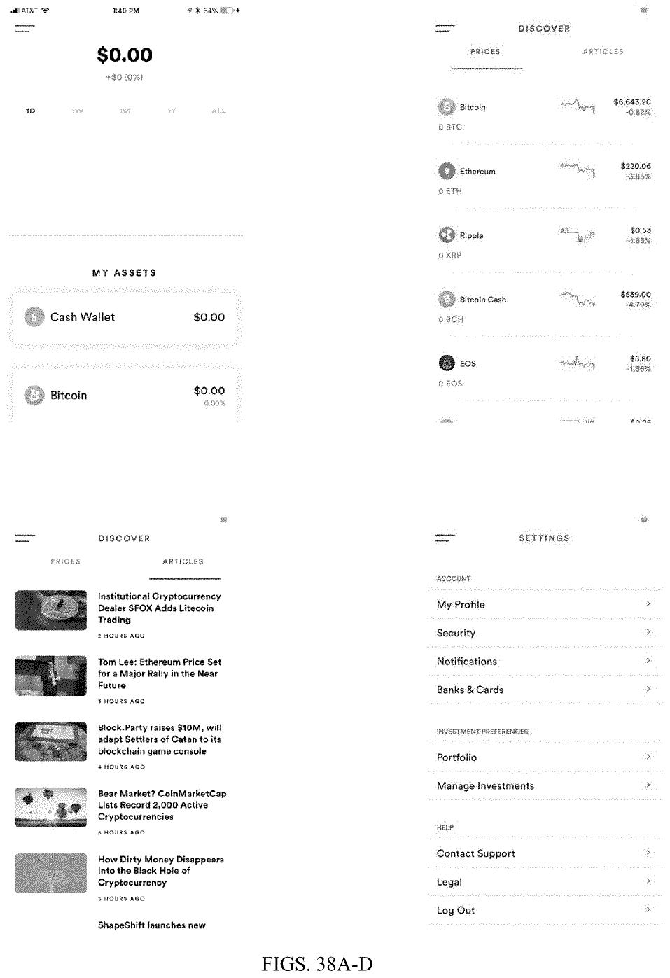

FIGS. 38A-D display screenshots illustrating various user interfaces of an application for distributing a cryptocurrency using a distribution system, in accordance with an exemplary embodiment.

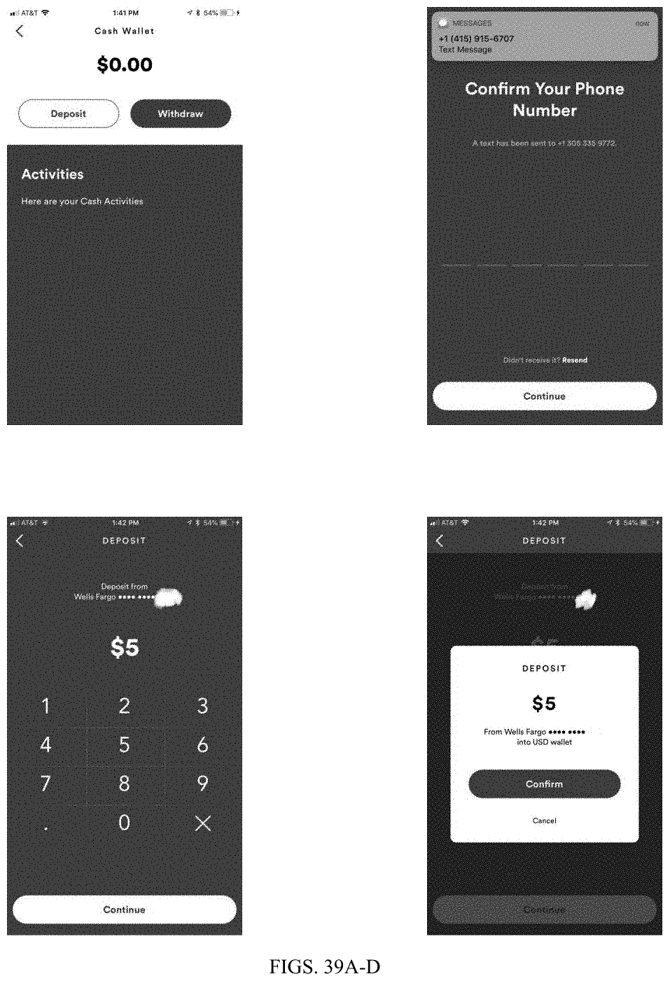

FIGS. 39A-D display screenshots illustrating various user interfaces of an application for distributing a cryptocurrency using a distribution system transferring the cryptocurrency from one account to another, in accordance with an exemplary embodiment.

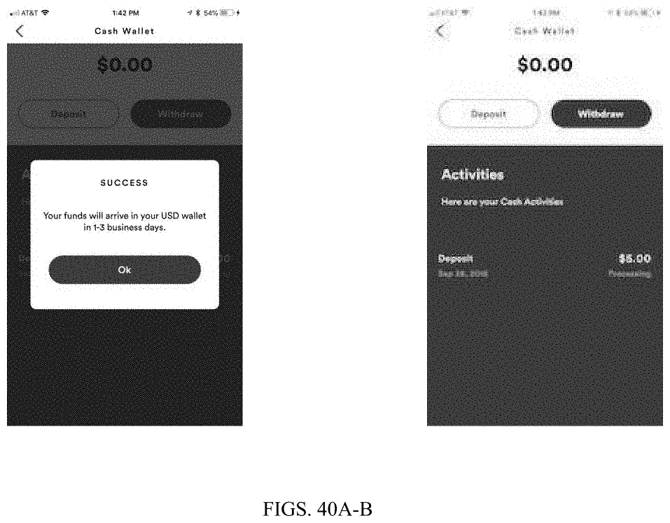

FIGS. 40A-B display screenshots illustrating various user interfaces of an application for distributing a cryptocurrency using a distribution system transferring the cryptocurrency from one account to another, in accordance with an exemplary embodiment.

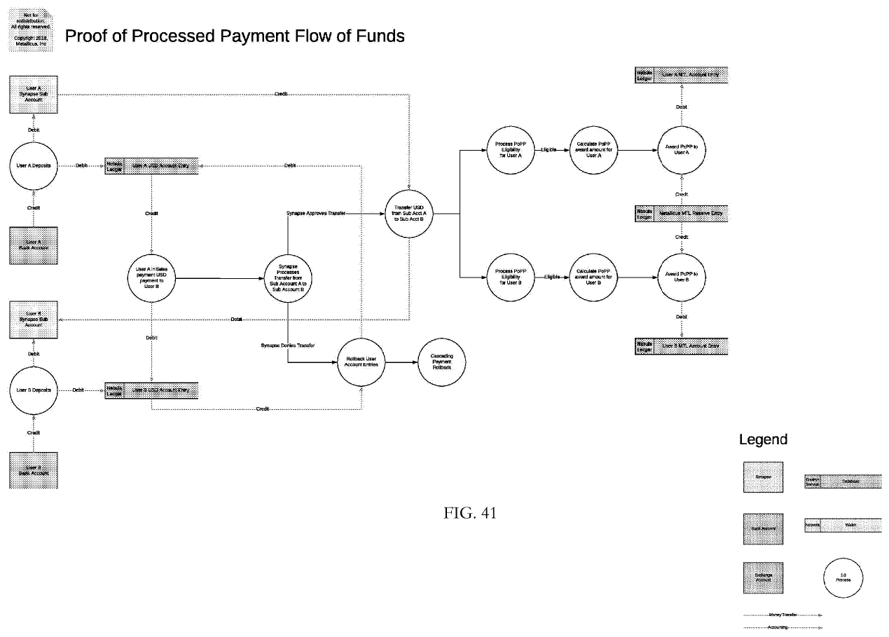

FIG. 41 shows a flow diagram for a specific embodiment of a method of distributing a cryptocurrency using a distribution system.

Before we dive in, we'd like to zoom out and remind you of our big picture goal. While it's true that Metal is centralized now, our distribution model PoPP will not remain exclusive to Metal Pay, or even to Metal. Yes, Metal Pay will help introduce cryptocurrency to the masses in a customer-facing app like nothing the crypto world has seen. But Metal Pay also lets us at Metal test our PoPP distribution model and make adjustments as needed before we release the PoPP ruleset to the world in our own blockchain. The Metal Blockchain will allow other cryptocurrencies to build apps around the PoPP distribution model to facilitate mass adoption of cryptocurrency.

Okay, time to zoom back in. You've probably seen and heard us talking about Pop, the reward you get inside of Metal Pay that is distributed via PoPP. But how much can you get? How do you get more? This post will focus on where Pop comes from and how it gets in your hands. Why are we starting here? Because Pop is what gets you paid for paying others.

First, let's define some terms so we're all on the same page.
PoPP—Proof-of-Processed-Payments. Our method for distributing all of the 26,341,112 MTL tokens that we set aside at the creation of MTL
PoPP pool—Where the 26,341,112 MTL is stored before it's sent out to Metal Pay users.
Pop—The MTL reward you get back each time you send or receive money in our app, Metal Pay.
Pop score—A score that is unique to each user, which defines a maximum % back that a user can receive in Pop after each transaction. Higher Pop score=more Pop=more $$$ coming your way.

Metal Pay is our payments app that rewards users with our cryptocurrency (MTL) for making and receiving payments. We use PoPP (distribution method, remember?) to give Metal Pay users a bit of Pop from the PoPP pool that is based on their Pop score. As it stands right now, PoPP distribution will last for at least 10 years. We have capped the total amount of Pop that we are distributing to users via PoPP at 7,200 MTL per day. A: Pop is distributed in blocks of 10 minutes. We distribute a maximum of 50 MTL every 10 minutes, which gives us our 7,200 MTL daily cap. At the end of every 10-minute block, the maximum Pop reward is calculated assuming there is no cap in place, and then is scaled down to meet the 50 MTL cap.

Example 1: Let's say that 1 MTL is worth $1. In the 10-minute window between 10:00 am and 10:10 am, 50 users on Metal Pay each sends a $20 transaction to 50 other people, and there are no other transactions during this 10-minute window. For the sake of this example, let's assume all users have a Pop score that makes them eligible to receive up to the maximum of 5% back. We also need to assume that all these transactions have processed and are no longer pending—it is “Proof-of-Processed-Payments” after all!

Volume of processed payments=50 transactions×20 dollars/transaction=$1000

Maximum Pop distribution per user=20 dollars×5% back=$1

Maximum Pop distribution=100 users×1 dollar/user=$100

Capped Pop distribution=50 MTL×1 dollar/MTL=$50

Actual Pop distribution per user=20 dollars×5% back×($50/$100)=$0.50

Your Pop score comes into play during the calculation of the maximum Pop you can receive. Example 2: Sticking with our 1 MTL=$1 assumption. In the 10-minute window between 10:00 am and 10:10 am, Alice sends Bob $1,000 on Metal Pay, and there are no other transactions during this 10-minute window. Alice has a Pop score that makes her eligible for a maximum of 5% back. Bob has a Pop score that makes him eligible for a maximum of 2% back.

Volume of processed payments=1 transaction×1000 dollars/transaction=$1000

Maximum Pop distribution for Alice=1000 dollars×5% back=$50

Maximum Pop distribution for Bob=1000 dollars×2% back=$20

Maximum total Pop distribution=$50 (to Alice)+$20 (to Bob)=$70

Capped Pop distribution=50 MTL×1 dollar/MTL=$50

Actual Pop distribution to Alice=$1000×5% back×($50/$70)=$35.72

Actual Pop distribution to Bob=$1000×2% back×($50/$70)=$14.28

We distribute Pop in 10-minute windows, so users will receive a Pop reward within 10 minutes after the payment has processed. If the payment is coming from a cash balance inside of Metal Pay, the payment will process instantly. If the payment is coming from a linked bank account, the processing time depending on the ACH processing rate for the user's linked bank—which could take a few business days. Clarification: While we must wait on the ACH processing to deliver Pop to you, the funds from you linked bank will arrive in your recipient's Metal Pay Cash balance instantly. A transaction amount, in an embodiment, must equal or exceed $1 to be eligible for Pop.

Things that will improve your Pop score:
Your network effect
   Bringing on new users to Metal Pay
   Making transactions with a large network of different people
   Making transactions more frequently
   NOTE: When we say “more frequently”, we're talking daily at best—we're not going to reward you with a higher Pop score for sending your friend $1 every minute for 10 minutes when you could have just sent them $10.
Your savings behavior
   Increasing your Cash balance in Metal Pay over time
   The total amount of Cash you hold within Metal Pay
   Increasing your MTL balance in Metal Pay over time
   The total amount of MTL you hold within Metal Pay
   NOTE: Purchasing MTL inside of Metal Pay is a quick way to increase your Pop score as it would check off 2 of the boxes above. Same for depositing Cash.
Your credit worthiness—we have our own system of calculating creditworthiness, including:
   Having a high percentage of transactions clear your bank account
   Keeping the same bank account linked to your account month-to-month
   Consistently making regular weekly or monthly payments (we will build out an automatic payments system to support this later).

Things that could potentially hurt your Pop score:
1. Quickly selling the MTL you receive from PoPP.
2. Making fraudulent transactions.
3. Attempting to abuse the PoPP distribution system.
NOTE: We reserve the right to suspend your ability to receive Pop indefinitely and/or suspend your account depending on the severity of the case(s).

The exact quantitative impacts that these rules have on your Pop score will not be displayed inside of Metal Pay, but will be made publicly available when we launch our own blockchain. To break it down in simple terms, you help us—we help you. You help us grow the Metal Pay network and save up MTL, we reward you with a higher Pop score, which allows you to earn more MTL.

The Pop scoring system is very complex and is based on a deep understanding of how people use Metal Pay. We don't want all of our users easily getting the maximum reward of up to 5%, because it would diminish the gamification element of Metal Pay. At the same time, we don't want to make the maximum reward of up to 5% impossible to achieve. We have to strike a balance between these, which requires a lot of data to get right. Because of this, the Pop scoring system will NOT be finalized until at least a few months after we launch the initial version of Metal Pay.

If you're an early adopter of Metal Pay, all users will be eligible to receive up to 5% back right from the start in our launch version of Metal Pay! As a reminder, being eligible for up to 5% back does not guarantee you will get 5% back, as the total reward handed out to all users in Metal Pay is capped to 50 MTL every 10 minutes in an exemplary embodiment.

Here is a brief summary of various embodiments that may affect Pop distribution:
All users who successfully pass KYC are eligible for Pop.
Users will start with the same Pop score.
   Users will not begin at the maximum reward of up to 5% back.
   By increasing their Pop score, a user can reach up to 5% back.
   By decreasing their Pop score, a user can reach as low as 0% back.
Users will be able to see their Pop score.
Users will not be able to see a friend's Pop score.
   Users may opt-in to reveal their Pop score to others, which could help with getting discounts from merchants or loans from lenders, for example.
Users will be given information on what they should try to do to raise their score.
Users will see the target score needed to reach a maximum of up to 5% back.
There will be a lifetime maximum amount of Pop that a user can claim.
   Each user will have their own lifetime maximum limit, which is influenced by their Pop score.
During certain promotional events, users will have a limited opportunity to claim a larger percentage back than they normally would.
   For example, a user with a Pop score that allows them to receive “up to 5% back”, may be eligible to receive “up to 10% back” during a 2× promotion event.
   Some events may be restricted to users with higher than average Pop scores.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

An exemplary system for implementing the subject matter disclosed herein, including the methods described above, includes a hardware device, including a processing unit, memory, storage, data entry module, display adapter, communication interface, and a bus that couples these elements to the processing unit.

The bus may comprise any type of bus architecture. Examples include a memory bus, a peripheral bus, a local bus, etc. The processing unit is an instruction execution machine, apparatus, or device and may comprise a microprocessor, a digital signal processor, a graphics processing unit, an application specific integrated circuit (ASIC), a field programmable gate array (FPGA), etc. The processing unit may be configured to execute program instructions stored in memory and/or storage and/or received via data entry module.

The memory may include read only memory (ROM) and random access memory (RAM). Memory may be configured to store program instructions and data during operation of device. In various embodiments, memory may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory may also include nonvolatile memory technologies such as nonvolatile flash RAM (NVRAM) or ROM. In some embodiments, it is contemplated that memory may include a combination of technologies such as the foregoing, as well as other technologies not specifically mentioned. When the subject matter is implemented in a computer system, a basic input/output system (BIOS), containing the basic routines that help to transfer information between elements within the computer system, such as during start-up, is stored in ROM.

The storage may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device.

It is noted that the methods described herein can be embodied in executable instructions stored in a non-transitory computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage ROM or RAM, including an operating system, one or more applications programs, program data, and other program modules. A user may enter commands and information into the hardware device through data entry module. Data entry module may include mechanisms such as a keyboard, a touch screen, a pointing device, etc. Other external input devices (not shown) are connected to the hardware device via external data entry interface. By way of example and not limitation, external input devices may include a microphone, joystick, game pad, satellite dish, scanner, or the like. In some embodiments, external input devices may include video or audio input devices such as a video camera, a still camera, etc. Data entry module may be configured to receive input from one or more users of device and to deliver such input to processing unit and/or memory via bus.

The hardware device may operate in a networked environment using logical connections to one or more remote nodes (not shown) via communication interface. The remote node may be another computer, a server, a router, a peer device or other common network node, and typically includes many or all of the elements described above relative to the hardware device. The communication interface may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface may include logic configured to support direct memory access (DMA) transfers between memory and other devices.

In a networked environment, program modules depicted relative to the hardware device, or portions thereof, may be stored in a remote storage device, such as, for example, on a server. It will be appreciated that other hardware and/or software to establish a communications link between the hardware device and other devices may be used.

It should be understood that the arrangement of hardware device is but one possible implementation and that other arrangements are possible. It should also be understood that the various system components (and means) defined by the claims, described above, and illustrated in the various block diagrams represent logical components that are configured to perform the functionality described herein. For example, one or more of these system components (and means) can be realized, in whole or in part, by at least some of the components illustrated in the arrangement of hardware device. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description above, the subject matter was described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

For purposes of the present description, the terms “component,” “module,” and “process,” may be used interchangeably to refer to a processing unit that performs a particular function and that may be implemented through computer program code (software), digital or analog circuitry, computer firmware, or any combination thereof.

It should be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for distributing a cryptocurrency using a distribution system, the method comprising:
receiving, by a processor of the distribution system, a request to transfer a first asset from a first user to a second user via a message received from a user device over a network, each user being associated with an account and a payment service;
transferring, by the processor, the first asset amount from the account of the first user to the account of the second user by contacting the payment services of both the first and second users;
determining, by the processor, that the transferring the first asset amount has been settled by the payment services of each of the first user and the second user by receiving a confirmation communication from at least one of the payment services;
determining, by the processor in response to determining that the transferring has been settled, amounts of a second asset to be remitted to each of the first user and the second user based on the first asset amount, the second asset being an encrypted cryptocurrency asset associated with a blockchain stored on a server in communication with the distribution system; and
distributing, by the processor, a first amount of the second asset to the first user and a second amount of the second asset to the second user in response to the determining that the transferring has been settled.
